(19) United States
(12) Patent Application Publication
(10) Pub. No.: US 2026/0300635 A1
(43) Pub. Date: Oct. 1, 2026

(54) METHOD AND SYSTEM FOR ASSISTING TEXT WRITING

(71) Applicant: Hong Kong Applied Science and Technology Research Institute Co., Ltd, Shatin (HK)

(72) Inventors: Chi Hang TAM, Shatin (HK); Chi ZHANG, Shatin (HK); Nanjun ZHOU, Shatin (HK); Jialin WU, Shatin (HK)

(21) Appl. No.: 19/095,214

(22) Filed: Mar. 31, 2025

(51) Int. Cl. G06F 40/35

(52) U.S. Cl. CPC G06F 40/35

(57) ABSTRACT

A method for assisting text writing, comprising steps of: (i) providing a text, as well as a first comment and a second comment associated with the text; (ii) defining multiple portions of the text with a neural network; (iii) associating, by the neural network, each of the first and second comments with one or more corresponding portions of the text to which the comment relates; the one or more corresponding portions of the text being the same or different for the first and second comments; and (iv) for each portion of the text, determining by the neural network whether the first comment contradicts the second comment, and outputting any contradiction found between the first and second comments.

### TECHNICAL FIELD

The present invention relates to a writing assistant tool. More particularly, the present invention relates to a method and system for assisting text writing using a neural network.

### BACKGROUND

In recent years, there has been a notable increase in the use of artificial intelligence (AI) in the field of text writing. This includes the generation of text articles based on users' requirements, the correction of grammatical errors within the article, and the provision of improved writing. Additionally, there are applications that utilise AI to offer feedback and suggestions for the improvement of a text, whether in terms of grammar or content, with the objective of enhancing the quality of the written composition.

In professional contexts, such as work and education, it is common practice for a text to be reviewed by more than one senior members of staff, in addition to the revision by the AI, before finalisation. During the revision process, different authors may provide different comments to the same subject matter of the text, which may sometimes contradict each other. Currently, there is no system in place to check for contradictions in comments and organise them. Consequently, manual revision is necessary to identify and address these inconsistencies, which can result in a substantial workload.

The existing writing assistant review systems have yet to implement AI techniques to perform comparison analysis, and human checking is required to verify that the expected modifications are applied, which is inefficient.

The invention seeks to mitigate or to at least alleviate such a problem or shortcoming by providing a new or otherwise improved method and system for assisting text writing.

### SUMMARY OF THE INVENTION

According to a first aspect of the present invention, there is provided a method for assisting text writing, comprising steps of: (i) providing a text, as well as a first comment and a second comment associated with the text; (ii) defining multiple portions of the text with a neural network; (iii) associating, by the neural network, each of the first and second comments with one or more corresponding portions of the text to which the comment relates; the one or more corresponding portions of the text being the same or different for the first and second comments; and (iv) for each portion of the text, determining by the neural network whether the first comment contradicts the second comment, and outputting any contradiction found between the first and second comments.

In an embodiment, the method further comprising a step of providing an explanation as to why the first and second comments are considered to be in contradiction.

In an embodiment, the first comment or the second comment comprises a suggestion for modification of the corresponding portion of the text.

In an embodiment, the step (iii) of associating the first comment with the corresponding portion of the text further comprises steps of: (i) filtering one or more portions of the text containing a keyword of the first comment; (ii) obtaining embedding similarity between the first comment and the one or more portions, and providing a score to each of the one or more portions based on the embedding similarity; and (iii) determining, by the neural network, the corresponding portion of the first comment among the one or more portions having the highest scores.

In an embodiment, the text is generated by the neural network based on an input requirement specified by a user.

In an embodiment, the generation of the text comprising steps of: (i) receiving the input requirement specified by the user; (ii) wrapping the input requirement with a first text template to provide a first input prompt; and (iii) generating, by the neural network, the text based on the first input prompt.

In an embodiment, the input requirement is in a form selected from any one of a text, an image, an audio, and a combination thereof.

In an embodiment, the first comment or the second comment is generated by the neural network based on a comment requirement specified by a user.

In an embodiment, the generation of the first comment or the second comment comprises steps of: (i) receiving the comment requirement specified by the user; (ii) wrapping the comment requirement with a second text template to provide a second input prompt; and (iii) generating, by the neural network, the first comment or the second comment based on the second input prompt.

In an embodiment, the comment requirement is selected from a target number of comments, an objective of comment, and a combination thereof.

In an embodiment, the method further comprising a step of ignoring at least a part of any one of the first comment and the second comment if the first comment contradicts the second comment, to provide a finalised set of comments comprising one or more comments which do not contradict with each other.

In an embodiment, the method further comprising a step of modifying the text by the neural network to provide a revised text based on the finalised set of comments.

In an embodiment, the method comprising a step of checking whether a revised text is amended based on the finalised set of comments, wherein the checking of the revised text comprising steps of: (i) providing the text, the finalised set of comments, and the revised text; (ii) associating, by the neural network, each portion of the text with one or more corresponding portions of the revised text to which the portion of the text most closely resembles; (iii) determining, by the neural network, whether each portion of the revised text is amended based on a corresponding comment within the finalised set of comments.

In an embodiment, the method further comprising a step of checking whether a revised text is amended based on the first comment or the second comment, wherein the checking of the revised text comprising steps of: (i) providing the text, the first and second comments associated with the text, and the revised text; (ii) associating, by the neural network, each portion of the text with one or more corresponding portions of the revised text to which the portion of the text most closely resembles; (iii) determining, by the neural network, whether each portion of the revised text is amended based on the first comment or the second comment.

In an embodiment, the neural network is a natural language processing (NLP) model or a large language model (LLM).

According to a second aspect of the present invention, there is provided a system for assisting text writing, comprising a revision module adapted to determine whether a first and second comments associated with a text contradict each other, wherein the revision module comprises: (i) a first unit adapted to provide a text, as well as the first and second comments associated with the text; (ii) a neural network adapted to define multiple portions of the text, associate each of the first and second comments with one or more corresponding portions of the text to which the comment relates, determine, for each portion of the text, whether a first comment contradicts a second comment, and output any contradiction found between the first and second comments; wherein the one or more corresponding portions of the text being the same or different for the first and second comments.

In an embodiment, the system further comprising a text generation module communicatively connected to the revision module, adapted to generate the text based on an input requirement specified by a user, wherein the text generation module comprises: (i) a second unit adapted to receive the input requirement specified by the user; (ii) a processing unit adapted to wrap the input requirement with a first text template to provide a first input prompt; and (iii) a neural network adapted to generate the text based on the first input prompt.

In an embodiment, the method further comprising a comparison module communicatively connected to the revision module, adapted to check whether a revised text is amended based on the first comment or the second comment, wherein the comparison module comprises: (i) a third unit adapted to provide the text, the first and second comments associated with the text, and the revised text; (ii) a neural network adapted to associate each portion of the text with one or more corresponding portions of the revised text to which the portion of the text most closely resembles, and determine whether each portion of the revised text is amended based on the first comment or the second comment.

In an embodiment, the revision module further comprises a comment generation unit adapted to generate the first comment or the second comment based on a comment requirement specified by a user, wherein the comment generation unit comprises: (i) a fourth unit adapted to receive the comment requirement specified by the user; (ii) a processing unit adapted to wrap the comment requirement with a second predetermined text template to provide a second input prompt; and (iii) a neural network adapted to generate the first comment or the second comment based on the second input prompt.

In an embodiment, wherein the neural network is a natural language processing (NLP) model or a large language model (LLM).

According to a third aspect of the present invention, there is provided a method for article and comment generation and comment verification, including (a) an article generation method that stores domain knowledge and capable of generate article according to users' instructions; (b) a revision method that generates comments to a given article, and validates the consistency between the comments; and (c) a comparison method that check if the modification requirements have been implemented in the new version.

In an embodiment, the method further comprises a step of utilizing a large language model that generates text output according to input.

In an embodiment, the method further comprises a step of utilizing an input conversion system which converts multiple types of input to text, including audio, .doc and .pdf.

In an embodiment, the method of comparison summarizes differences two documents, and capable of receiving a list of suggested changes and verify them.

In an embodiment, the method further comprises a step of using a scoring system that computes the connection between two paragraphs.

In an embodiment, the method further comprises a step of using a sentence embedding system that assign a vector to every string.

An embodiment of the present invention provides a method using a neural network to review and determine if there are inconsistencies between comments provided by two or more reviewers, such that the efficiency of an existing writing assistance tool can be improved and any tedious manual work in checking for inconsistencies can be avoided.

### BRIEF DESCRIPTION OF THE FIGURES

The invention will now be more particularly described, by way of example only, with reference to the accompanying drawings, in which:

FIG. 1 is a flow diagram showing an embodiment of a method for assisting text writing according to the present invention;

FIG. 2a is a schematic diagram showing a step of determining a contradiction between two comments, in accordance with a method of the present invention;

FIG. 2b is a schematic diagram showing a step of disabling one of the two comments as shown in FIG. 2a, due to a contradiction between them;

FIG. 3 is a flow chart showing steps of generating a text passage based on users' requirements, in accordance with a method of the present invention;

FIG. 4 is a flow chart showing steps of providing comments and modification suggestions to a text, in accordance with a method of the present invention;

FIG. 5 is a flow chart showing steps of determining whether two sets of comments contradict with each other, in accordance with a method of the present invention;

FIG. 6 is a flow chart showing steps of confirming whether the text is modified according to the modification suggestions made thereto, in accordance with a method of the present invention;

FIG. 7a is a screenshot of an application utilising an assisted writing tool according to the present invention, wherein there are no contradictions between comments;

FIG. 7b is a screenshot of the application of FIG. 7a, wherein contradictions are present between comments; and

FIG. 8 is a workflow diagram showing operation procedures of an embodiment of a system according to the present invention.

### DETAILED DESCRIPTION OF THE EMBODIMENTS

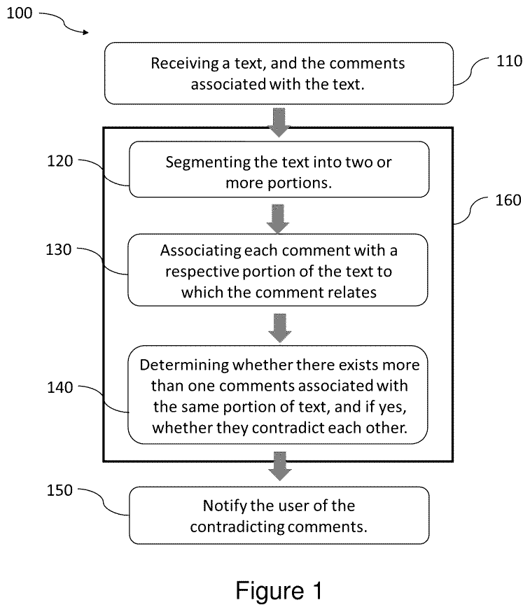

An embodiment of the present invention provides a method and a system for assisting text writing, in order to enable more efficient writing which reduces the need for manual review of contradictory comments regarding the text. As illustrated in FIG. 1, which details an embodiment of the assisted text writing method 100 according to the present invention, the implementation of a neural network 160 is essential for consolidating and reviewing any existing comments associated with a specific portion of the text. The initial step 110 of the method 100 involves receiving a text, which may be an essay or a paragraph of text, along with comments that include modification suggestions pertaining to the text. When comments are generated by different authors, such as between two reviewers or between a reviewer and an AI engine, discrepancies arise between the two or more sets of comments. While at times such discrepancies do not matter in terms of generating a revised text, as they may suggest two different amendments that can co-exist within a passage, there are times when the two comments refer to the same part of the passage and at the same time contradict each other.

This leads to the second step 120 of the method 100 of the present invention, which is to define multiple portions of the text by the neural network 160, such as a Large Language Model (LLM). In a third step 130, also performed by the neural network 160, each of the comments provided by the users or the AI engine is associated with a respective portion of the text, to which the comment relates. The neural network 160 would then, in the fourth step 140, check whether there are more than one comments relating to the same portion of text and, if so, determine whether the comments create conflict with each other. If the two or more comments relating to the same portion of text are indeed contradictory with each other, such comments are output in the fifth step 150 to inform the user of the inconsistency so that the user can review and choose to proceed with one of them.

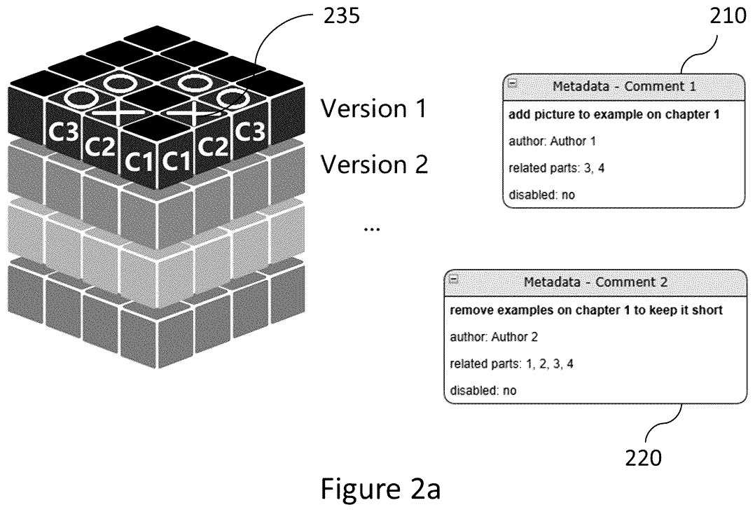

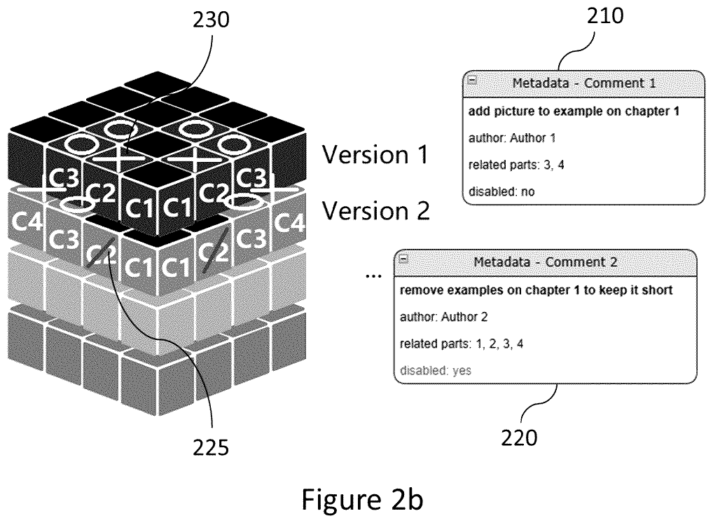

FIGS. 2a and 2b further illustrate the operating logic behind the step 140 of determining a contradiction between the two comments by the neural network 160. In the context of an embodiment of the present invention, a contradiction between two or more comments is defined as the overlap of their associated text portions being non-empty and the comments being incapable of being addressed simultaneously. As the comments are fed into the neural network, metadata is created for each comment, comprising the components of (i) comment content, (ii) author, and (iii) the associated portion of text to which the comment is associated (related part). An example of which is shown in comment one 210 and comment two 220 in FIGS. 2a and 2b. Both comments 210, 220 relate to parts 3 and 4 of the text, and while comment one 210 suggests “adding a picture to the example in chapter 1”, comment two 220, written by a different author, suggests the opposite, “removing example in chapter 1 to keep it short”. The neural network determines that there is a contradiction 230 between the two comments 210, 220 because they cannot be addressed simultaneously within the same passage of text, i.e. one cannot add a further picture to the example if such an example is to be removed. The contradiction 230 would then be output to a user for consideration as to which comment, 210 or 220 should be retained. In an embodiment, such a consideration is made by the neural network.

As shown in FIG. 2b, the text with the contradiction 230 between the comments 210, 220 are passed to a user for review, who creates a second version of the text in which data from the previous version is brought forward. The user may add new comments C4 in addition to the previous comments and may choose to ignore or disable comment two 220, indicated by the slash symbol 225, and retain only comment one 210 to avoid contradiction 230.

In an embodiment, in the event of contradiction 230 arising between comments, a report will be generated and output to users. This report will summarise all contradictions within the text, together with explanatory notes. The following example illustrates a contradiction/conflict:

### Conflict 1

| Comment ID | Comment content | Related parts |
|---|---|---|
| Comment 3 | Remove unnecessary data on Section 3 | 10, 11 |
| Comment 5 | Elaborate on details on Section 3 | 11 |

LLM Explanation: Conflict exists between Comments 3 and 5. There is a contradiction on ‘Remove unnecessary data’ and ‘Elaborate on details’ on the same place of the document.

In an embodiment, a specified level is assigned to each user providing the comments. If the comments provided by two or more users contradict each other, only the comment provided by the user with the highest level is retained. Other comments from users with lower levels are ignored.

The present invention also provides a system that provides an all-in-one service for generating a text, providing comments on the text and checking for any inconsistencies with the comments, and revising the text based on the comments.

In an embodiment, a system of the present invention comprises three modules, including a text generation module, a revision module and a comparison module, which are communicatively connected to each other to provide a text based on the user's requirements and to improve the writing thereof. The text generation module is adapted to receive various types of input and generate a text according to the user's requirements. The revision module is adapted to provide comments including modification suggestions to the text, and check for the consistency of the comments. The comparison module is adapted to compare two texts and show their differences, it also accepts a list of suggested modifications as input, and check whether the suggested modifications are applied in the new version text.

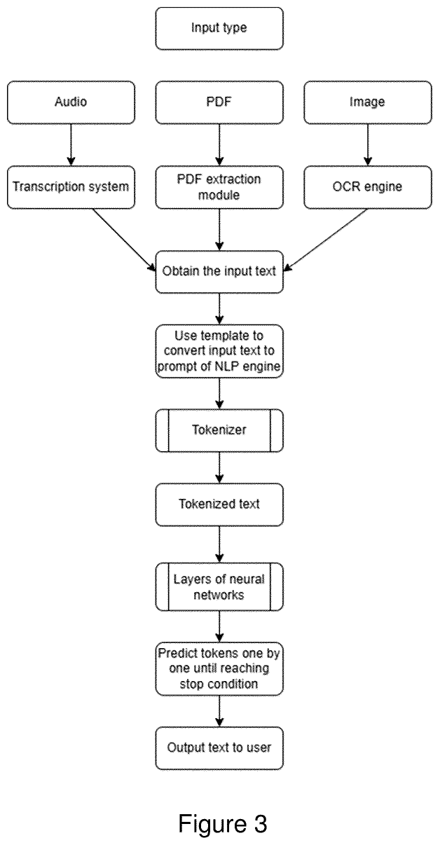

FIG. 3 shows the steps taken by the text generation module to generate text based on users' requirements. First, an input is fed into the module, specifying the user's requirements for the generated text. The module accepts several types of input, including text (including .doc and .pdf), images and audio. Non-text input is first converted to text before being fed into the text generation module. In an embodiment, the text generation module comprises a transcription system for converting an audio file to text, a transcription system for converting audio to text, a PDF extraction method for converting a PDF file to text, and an OCR engine for extracting text from an image. Next, the input text is wrapped by predefined templates, which is in machine language, to obtain the input prompt. The input prompt is then fed into a natural language processing (NLP) engine to generate an article based on the input. The basic working principles of the NLP engine include (i) converting the input prompt into tokens using a tokenizer, (ii) passing the list of tokens through a layer of a neural network, (iii) generating a list of possible next words with their possibilities by the neural network, and (iv) selecting the most probable word. This process is repeated to generate an article.

After an article has been generated by the text generation module, the article is then fed into the revision module to provide comments and check for consistency between comments. Alternatively, a user can skip the text generation process of FIG. 3 and input a self-written article to obtain comments on the article.

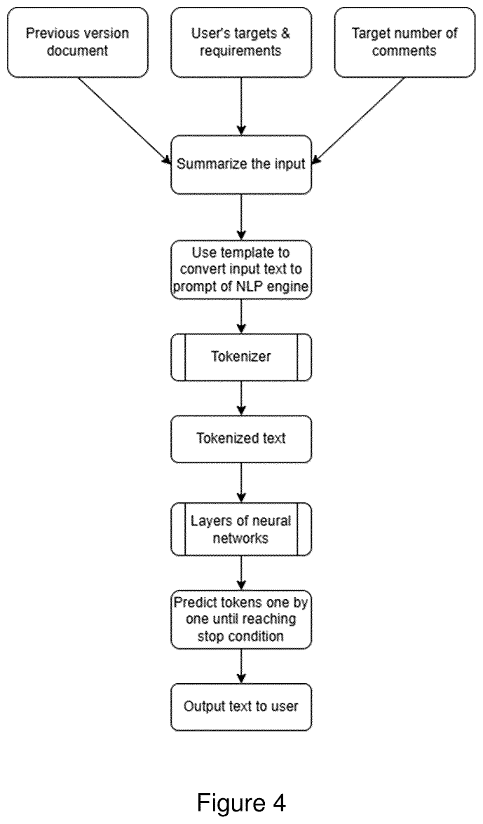

FIG. 4 shows the workflow of an embodiment of the revision module according to the present invention. The revision module receives a text as input, where the text is either an AI generated article provided by the text generation module or a self-written article provided by the user. In an embodiment, the text is a single article, or alternatively, it refers to a project comprising multiple articles. After importing the text, users can specify the requirements and targets of the comments they wish to receive, including the number of comments. The article, together with the specified requirements, is then organised into an input prompt with a predefined template, and the input prompt is sent to the NLP engine. Similar NLP techniques to those used in the text generation module are also used in the revision module. Finally, comments and suggested modifications are generated by the NLP engine.

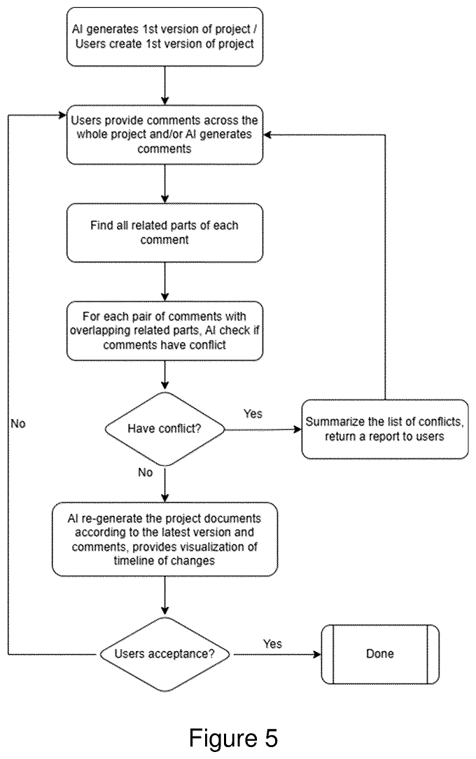

FIG. 5 shows the steps involved in summarising the comments and checking for inconsistencies. As mentioned previously, the checking process comprises steps of defining the article into a number of portions and associating each comment with a corresponding portion of the article to which the comment relates. In an embodiment, the revision module utilises two methods for determining which part of the document is related to the comment. The first method is hierarchical filtering, which consists of the following steps:
1. Initial filtering (keyword matching), where paragraphs containing explicit keywords are quickly filtered out of the comments.
2. Semantic filtering (embedding), where the cosine similarity between the comments and the filtered paragraphs is computed using an embedding model. The property of embedding vectors is the smaller distance between two or more similar texts.
3. Final Validation (LLM Verification), where an LLM is used to validate the relevance of the top k paragraphs with the highest similarity scores. In an embodiment, users can control the method of selecting the best paragraphs, including modifying the value of ‘k’ or setting a threshold.

The second method involves the direct application of LLM. For each part of the document, ask LLM whether it is relevant to the comment. This can be facilitated by including surrounding context, such as three parts before and after, in order to provide a more comprehensive evaluation.

The revision module then checks whether there are two or more comments for each part of the document and, if so, whether the comments contradict each other. Conflicting comments are brought to the attention of the users, who then decide which comment to keep and disable the other conflicting comments. Alternatively, the LLM can be trained to select the comments. This process is repeated until all conflicting comments have been dealt with that no further conflicting comments are present. The remaining comments and the text are then sent to the comparison module for the generation of a revised document.

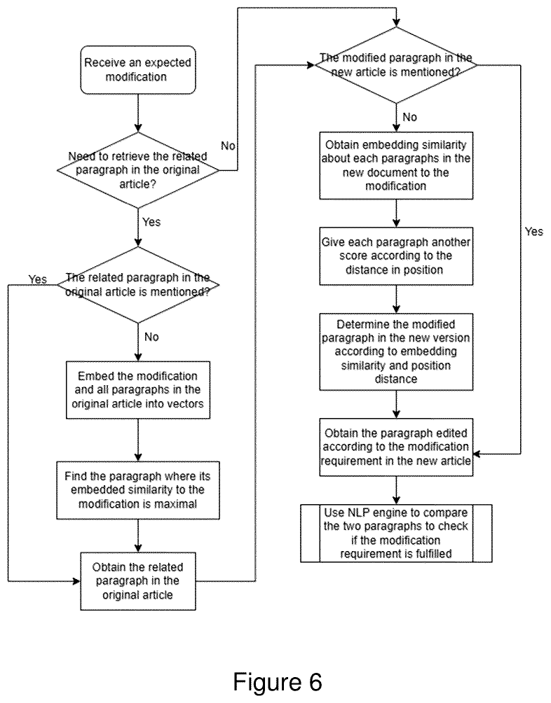

The operation of the comparison module is shown in FIG. 6. The comparison module receives a text article and a set of non-conflicting, finalised comments as input. In an embodiment, the set of comments is provided by the revision module. Alternatively, the comments can be provided by the user. If the comments are indeed provided by the user and not by the revision module, the comparison module must first perform the segmentation steps as in the revision module to divide the article into a plurality of portions and to associate each comment in the set with a respective part to which it relates. However, if the text and comments are passed from the revision module, these steps can be omitted as they have been carried out in the revision module.

The comparison module is adapted to ensure that all comments, including the suggested modifications, are taken into account in the revised article. To do this, the module first determines whether the related paragraph in the original article is mentioned in the revised article. This can be achieved by embedding the modification and all paragraphs in the original article into vectors, finding the paragraph(s) where its embedded similarity to the modification is maximal, and obtaining the related paragraph(s) in the original article.

Then, the comparison module considers whether the modified paragraph in the new article is mentioned. This is done by determining the embedding similarity of each paragraph in the new document to the amendment, giving each paragraph another score according to positional distance, determining the modified paragraph in the new version according to embedding similarity and positional distance, and obtaining paragraph(s) in the new article that has been edited according to the modification requirement. Finally, the NLP engine is used to compare the two paragraphs to check that the medication requirement is met. Alternatively, a user can manually associate the amended portion of the revised article to the related portion of the original article.

In an embodiment, for the ‘change’ and ‘delete’ modifications, it is assumed that the position of the related paragraph in the new version is more likely to be near the corresponding paragraph in the old version. Both factors, paragraph position and embedding similarity, are taken into account. The comparison module then finds the most related paragraph in the new version of the document. In an embodiment, a user can be involved to check that the correct paragraph is selected, or to specify the correct paragraph to which the comment is related. After locating both paragraphs, both the related paragraphs and the expected modification are imported as an input prompt, and then an NLP engine is used to compare whether the given change is applied. The results of the comparison are presented visually to the user.

In an embodiment, the NLP engine has two roles in the system according to the present invention, including as a writer, which generates a written article according to the requirements and comments specified by the users, and also as a reviewer, which reviews the document and provides comments, checks the comments of all users and verifies their consistency, and checks whether the latest version of the article contains the required changes. This cycle can be repeated a number of times, or can be terminated at the users' discretion.

The following is an example of the application of the present invention comprising the steps of:
1. The user enters the requirements of the article to be produced. (i.e. by typing “Please write an article introducing product features of <features>. The details are attached here: <Technical Details> and my requirements are: <Requirements>” to the system).
2. The text generation module generates an article.
3. The review module reviews the article and generates comments.
4. A list of comments is generated and presented to the user.
5. After reviewing the document, the user provides additional comments.
6. The revision module analyses all the comments available. If there are any conflicts between the comment, present them to the user for modification.
7. On receiving the list of conflicting comments, the user updates the comments to make them consistent.
8. The revision module analyses all comments. If it is determined that there are no conflicts between comments, the review engine rewrites the document according to the comments.
9. The comparison module compares and determines whether all the comments are reflected in the new version of the document.
10. If it is determined that some comments are not attended to in the new document, the compare module rewrites the document.
11. A new revision document is generated.
12. The comparison module compares and determines again whether all the comments are reflected in the new version document. The number of repetitions can be limited to prevent the process from entering a dead loop.
13. If all comments are correctly addressed. Return to the user.

After reviewing the article, if the user has new comments, go back to step 3 or 5, otherwise the workflow is complete.

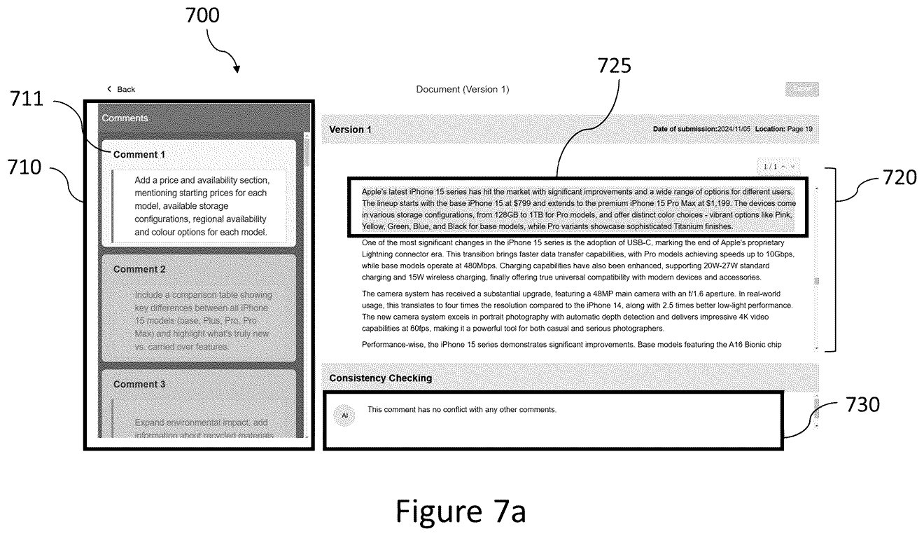

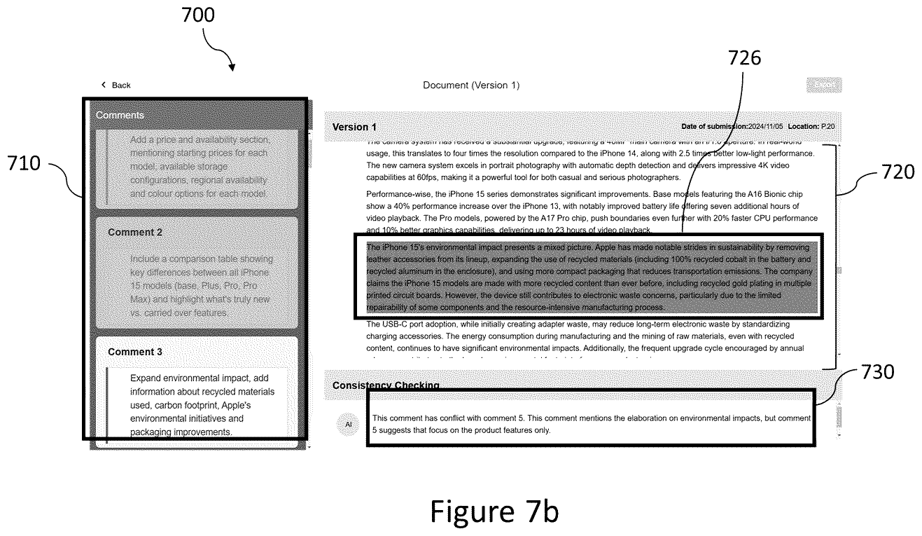

FIGS. 7a and 7b show screenshots of an actual application using the text assistance system of the present invention. In the application window 700, the comments 710 provided by the user or the revision module are shown on the left and the processed text 725 is shown on the right. For each comment, the system attempts to locate its relevant part in the text, highlight it and check whether there exist other comments which may conflict with it. For example, the selected comment one 711 in FIG. 7a corresponds to the highlighted paragraph 725 and it is displayed in the consistency checking panel 730 that there are no conflicting comments with respect to the highlighted paragraph 725. However, another paragraph 726, which is highlighted in FIG. 7b, is associated with more than one comments, and it is determined by the system that the comments are in conflict with each other. Therefore, the consistency checking panel 730 displays “Comment 3 contradicts comment 5” and further explains why the two comments contradict each other. A user, upon seeing such a comment, is obliged to review the comments and decide which comment, in this case comment 3 or comment 5, should be disabled.

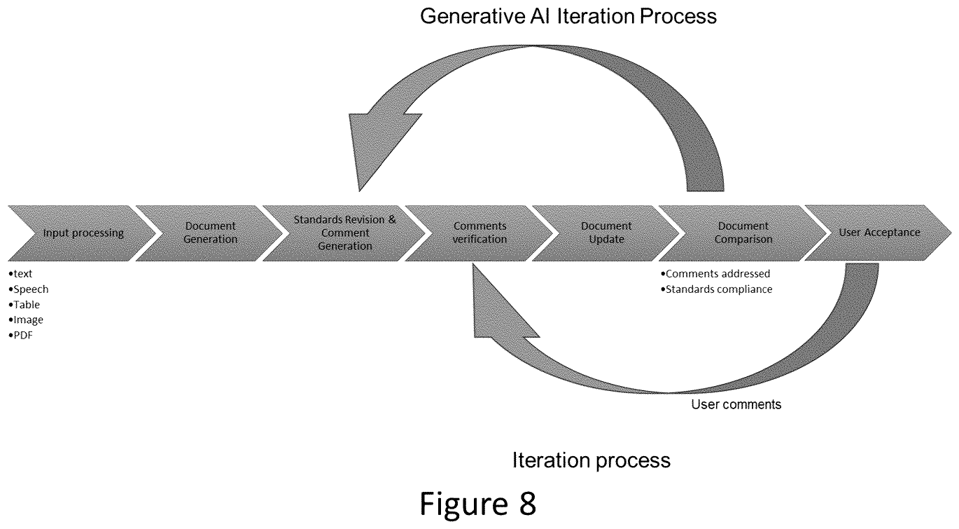

FIG. 8 shows the flow of a single user applying the system to generate and optimize an article according to an embodiment of the present invention. The flow includes the following steps:
1. User designs task template
2. System generates article based on template using text generation module
3. System generates comments on article using review module
4. User can review and modify comments or add new comments
5. System checks consistency between comments
6. System rewrites article based on comments using text generation module
7. Repeat steps 3 to 6 until a satisfactory article is generated.

The flow also applies to the interaction between a writer and a reviser, wherein the steps including:
1. Writer designs task template
2. System generates article based on template using the text generation module
3. Writer checks and fine-tunes article and sends it to reviser
4. Reviewer uses system to generate comments through review module, and can integrate with their own comments
5. System checks for consistency between comments
6. Authors modify the article according to the comments
7. Reviser checks if the comments are applied by comparison module
8. Repeat steps 3 to 7 to optimize the article.

In an embodiment, the NLP or LLM engines utilised in the system of the present invention include llama3.3 and deepseek-r1.

In an embodiment, the comments are generated with the corresponding position labelled (e.g. section ID) so that the comparison module does not need to check for the position. The prompt can be modified to allow the NLP engine to output the associated position. This can increase the accuracy of the comparison module.

An embodiment of the present invention provides an automatic and transparent generation method that can keep track of different versions and corresponding comments. It differs from conventional LLM in that while using LLM to directly generate and optimise articles may require several interactions between human and AI engine, the present system maintains automation and provides visualisation of the generation process to the user.

The invention has been given by way of example only, and various other modifications of and/or alterations to the described embodiment may be made by persons skilled in the art without departing from the scope of the invention as specified in the appended claims.

The embodiments of the invention in which an exclusive property or privilege is claimed are defined as follows:

1. A method for assisting text writing, comprising steps of:
(i) providing a text, as well as a first comment and a second comment associated with the text;
(ii) defining multiple portions of the text with a neural network;
(iii) associating, by the neural network, each of the first and second comments with one or more corresponding portions of the text to which the comment relates; the one or more corresponding portions of the text being the same or different for the first and second comments; and
(iv) for each portion of the text, determining by the neural network whether the first comment contradicts the second comment, and outputting any contradiction found between the first and second comments.

2. The method according to claim 1, further comprising a step of providing an explanation as to why the first and second comments are considered to be in contradiction.

3. The method according to claim 1, wherein the first comment or the second comment comprises a suggestion for modification of the corresponding portion of the text.

4. The method according to claim 1, wherein the step (iii) of associating the first comment with the corresponding portion of the text further comprises steps of:
(i) filtering one or more portions of the text containing a keyword of the first comment;
(ii) obtaining embedding similarity between the first comment and the one or more portions, and providing a score to each of the one or more portions based on the embedding similarity; and
(iii) determining, by the neural network, the corresponding portion of the first comment among the one or more portions having the highest scores.

5. The method according to claim 1, wherein the text is generated by the neural network based on an input requirement specified by a user.

6. The method according to claim 5, wherein the generation of the text comprising steps of:
(i) receiving the input requirement specified by the user;
(ii) wrapping the input requirement with a first text template to provide a first input prompt; and
(iii) generating, by the neural network, the text based on the first input prompt.

7. The method according to claim 5, wherein the input requirement is in a form selected from any one of a text, an image, an audio, and a combination thereof.

8. The method according to claim 1, wherein the first comment or the second comment is generated by the neural network based on a comment requirement specified by a user.

9. The method according to claim 8, wherein the generation of the first comment or the second comment comprises steps of:
(i) receiving the comment requirement specified by the user;
(ii) wrapping the comment requirement with a second text template to provide a second input prompt; and
(iii) generating, by the neural network, the first comment or the second comment based on the second input prompt.

10. The method according to claim 9, wherein the comment requirement is selected from any one of a target number of comments, an objective of comment, and a combination thereof.

11. The method according to claim 1, further comprising a step of ignoring at least a part of any one of the first comment and the second comment if the first comment contradicts the second comment, to provide a finalised set of comments comprising one or more comments which do not contradict with each other.

12. The method according to claim 11, further comprising a step of modifying the text by the neural network to provide a revised text based on the finalised set of comments.

13. The method according to claim 11, further comprising a step of checking whether the revised text is amended based on the finalised set of comments, wherein the checking of the revised text comprising steps of:
(i) providing the text, the finalised set of comments, and the revised text;
(ii) associating, by the neural network, each portion of the text with one or more corresponding portions of the revised text to which the portion of the text most closely resembles;
(iii) determining, by the neural network, whether each portion of the revised text is amended based on a corresponding comment within the finalised set of comments.

14. The method according to claim 1, further comprising a step of checking whether a revised text is amended based on the first comment or the second comment, wherein the checking of the revised text comprising steps of:
(i) providing the text, the first and second comments associated with the text, and the revised text;
(ii) associating, by the neural network, each portion of the text with one or more corresponding portions of the revised text to which the portion of the text most closely resembles;
(iii) determining, by the neural network, whether each portion of the revised text is amended based on the first comment or the second comment.

15. The method according to claim 1, wherein the neural network is a natural language processing (NLP) model or a large language model (LLM).

16. A system for assisting text writing, comprising a revision module adapted to determine whether a first comment and a second comment associated with a text contradict each other, wherein the revision module comprises:
(i) a first unit adapted to provide a text and the first and second comments associated with the text;
(ii) a neural network adapted to define multiple portions of the text; associate each of the first and second comments with one or more corresponding portions of the text to which the comment relates, wherein the one or more corresponding portions of the text being the same or different for the first and second comments; determine, for each portion of the text, whether a first comment contradicts a second comment; and output any contradiction found between the first and second comments.

17. The system according to claim 16, further comprising a text generation module communicatively connected to the revision module, adapted to generate the text based on an input requirement specified by a user, wherein the text generation module comprises:
(i) a second unit adapted to receive the input requirement specified by the user;
(ii) a processing unit adapted to wrap the input requirement with a first text template to provide a first input prompt; and
(iii) a neural network adapted to generate the text based on the first input prompt.

18. The system according to claim 16, further comprising a comparison module communicatively connected to the revision module, adapted to check whether a revised text is amended based on the first comment or the second comment, wherein the comparison module comprises:
(i) a third unit adapted to provide the text, the first and second comments associated with the text, and the revised text;
(ii) a neural network adapted to associate each portion of the text with one or more corresponding portions of the revised text to which the portion of the text most closely resembles; and determine whether each portion of the revised text is amended based on the first comment or the second comment.

19. The system according to claim 16, wherein the revision module further comprises a comment generation unit adapted to generate the first comment or the second comment based on a comment requirement specified by a user, wherein the comment generation unit comprises:
(i) a fourth unit adapted to receive the comment requirement specified by the user;
(ii) a processing unit adapted to wrap the comment requirement with a second predetermined text template to provide a second input prompt; and
(iii) a neural network adapted to generate the first comment or the second comment based on the second input prompt.

20. The system according to claim 16, wherein the neural network is a natural language processing (NLP) model or a large language model (LLM).
